(19) United States
(12) Patent Application Publication
(10) Pub. No.: US 2025/0254372 A1
(43) Pub. Date: Aug. 7, 2025

(54) MODULE FOR A CABLE TV NETWORK DISTRIBUTION TAP

(71) Applicant: TECHNETIX B.V., Veenendaal (NL)

(72) Inventors: Gareth SHELLEY, Veenendaal (NL); Kristian DEAN, Veenendaal (NL); Paul CHAPMAN, Veenendaal (NL)

(21) Appl. No.: 18/934,149

(22) Filed: Oct. 31, 2024

(30) Foreign Application Priority Data
Feb. 6, 2024 (GB) 2401549.7

(51) Int. Cl. H04N 21/226

(52) U.S. Cl. CPC H04N 21/226

(57) ABSTRACT

There is provided a module (40) for a cable TV network distribution tap comprising an insert (42) locatable over a power pass bar (24) and an activation switch (26) located in a Cisco/Scientific Atlanta back box (10) and at least one support element (52) mounted on the insert (42) and moveable to locate at least part of the support element (52) beneath the power pass bar (24). When a faceplate is mounted on the back box, the pivot axis of the power pass bar is changed to ensure the power pass bar does not physically contact connectors on which terminals are mounted.

### FIELD OF THE INVENTION

This invention relates to a module for a back box component of a broadband distribution tap used in cable TV (CATV) networks.

### BACKGROUND TO THE INVENTION

Distribution taps are used in CATV networks to connect broadband services to subscriber homes. A CATV distribution tap consists of a permanently connected back box and a removable faceplate on which is mounted a coupler circuit that divides the signal between the output and an internal splitter circuit, which subsequently divides the remaining signal equally between 2, 4 or 8-way tap outputs that connect to subscriber premises via coaxial cables. The faceplate and back box connect electrically via two internal connectors.

In a CATV network, the taps are cascaded together with the output of one tap connected to the input of the next in the chain. To extend the reach of the network amplifiers are positioned throughout the chain to boost the broadband signal. As technology has advanced, the frequency band over which CATV signals are transmitted has increased, which has required the upgrading of the tap faceplates. The faceplate circuits and components have become more complex and in some cases the faceplates have increased in depth to accommodate larger components.

Each tap back box contains a mechanical switched bypass circuit that connects the output to the input when the faceplate is removed for maintenance or upgrade, thus maintaining power and signal to all downstream taps and amplifiers. When the faceplate is re-fitted, a protrusion on the faceplate depresses a mechanical bypass actuator switch, disconnecting the bypass circuit just after the faceplate circuit is connected. The switch is referred to as a “Make Before Break” (MBB) switch.

The design of the mechanical bypass switch is often a limiting factor in extending the operational bandwidth or the tap above 1.2 GHz due to resonances and mismatches caused in the faceplate circuits when the faceplate is mounted on the back box and the switch is in its open position.

It is difficult and time consuming to replace the tap back boxes once installed in a network and replacing back boxes would also cause the signal to all downstream subscribers to be interrupted, hence network operators prefer to only replace the faceplates.

The Cisco/Scientific Atlanta variant of distribution taps are limited in their operational bandwidth above 1.2 GHz due to the construction of the MBB switch. Simply replacing the faceplate to increase the operational bandwidth above 1.2 GHz does not work, so a modification to the back box is required to enable higher frequency operation of the existing back box.

### SUMMARY OF THE INVENTION

In accordance with one aspect of the present invention, there is provided a module for a cable TV network distribution tap comprising an insert locatable over a power pass bar and an activation switch located in a Cisco/Scientific Atlanta back box and at least one support element mounted on the insert and moveable to locate at least part of the at least one support element beneath the power pass bar. By locating at least part of the support element beneath the power pas bar, the pivot axis of the power pass bar will be modified when a faceplate is mounted on the back box, ensuring the power pass bar does not physically contact support blocks on which terminals are mounted. This ensures there is an air gap between the power pass bar and the support blocks, reducing capacitive coupling.

The at least one support element is preferably rotatable by 90 degrees between a first position parallel to the power pass bar and a second position where at least part of the at least one support element is beneath the power pass bar. Indicia or grooves may be used on the indicia to indicate correct positioning of at least part of the support element under the power pass bar.

The insert may comprise a channel to receive the power pass bar and an aperture to receive an activation switch. The insert may further comprise stop regions to limit movement of the at least one support element.

Preferably two support elements are mounted proximal opposing ends of the insert.

In accordance with another aspect of the invention there is provided a Cisco/Scientific Atlanta back box incorporating a module according to any of the preceding claims.

The invention will now be described, by way of example, with reference to the accompanying drawings in which:

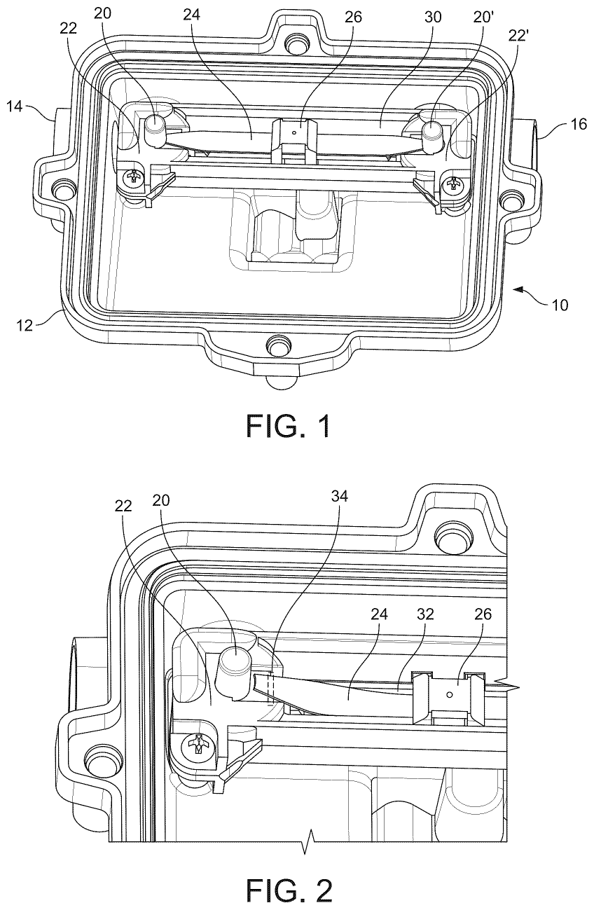

FIG. 1 is a perspective view from above of a Cisco/Scientific Atlanta back box showing a power pass bar;

FIG. 2 is a detailed view of the back box of FIG. 1 when the power pass bar is disconnected;

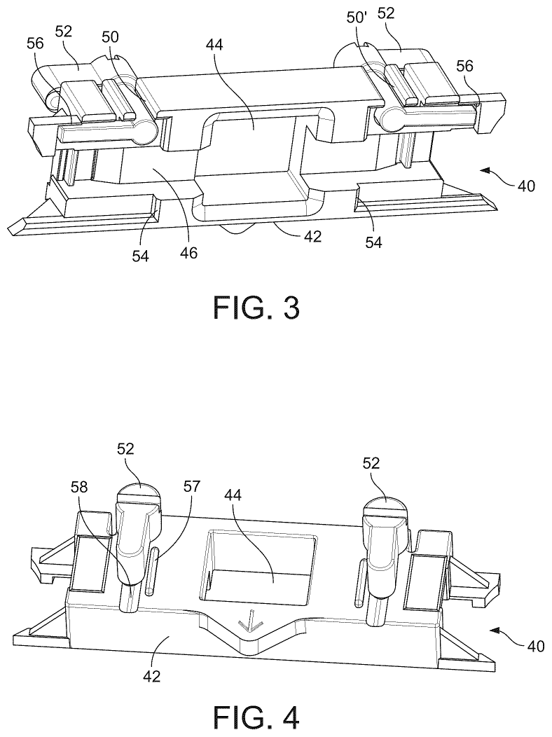

FIG. 3 is a view from below of a module for insertion in the back box;

FIG. 4 is a perspective view from above of the module;

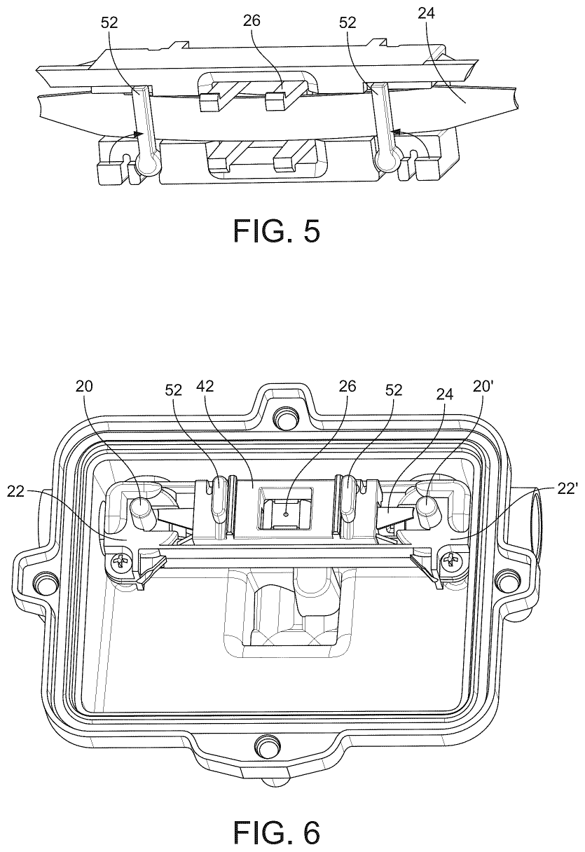

FIG. 5 is a perspective view from below of the module when positioned over the power pass bar; and

FIG. 6 shows a perspective view of the back box with module when the power pass bar is disconnected.

### DESCRIPTION

A Cisco/Scientific Atlanta back box 10 is shown in FIG. 1 and comprises back box housing 12 with network input connection 14 and network output connection 16, connector terminals 20, 20′ each surrounded by a respective plastics connector support block 22, 22′, power pass bar 24 extending between connector terminals 20, 20′ and an actuator switch 26 for disconnecting power pass bar 24 from connector terminals 20, 20′ when a faceplate is mounted on back box 10. Channel 30 extends between connector support blocks 22, 22′ and has a central groove 32, see FIG. 2, to receive power pass bar 24 when it is deflected downwards by actuator switch 26 and disconnected.

In distribution taps, the operational bandwidth above 1.2 GHz is limited due to coupling between the connector blocks and the power bypass bar. This is significant on a Cisco/Scientific Atlanta back box because when a faceplate is fitted and actuator switch 26 activated as shown in FIG. 2, power pass bar 24 slides downwards into groove 32 but remains in physical contact with connector support blocks 22, 22′ in region 34. This results in a high capacitive coupling between connector terminals 20, 20′ and the disconnected power pass bar 24 and limits the operational frequency of a Cisco/Scientific Atlanta back box to below 1.2 GHz.

To resolve this issue and as shown in FIGS. 3 and 4, an add-on module 40 is provided that clips onto the existing MBB assembly of power pass bar 24 and actuator switch 26 to alter the pivot point of axis of bar 24 to enable increased operational bandwidth without causing disruption to the system power.

Module 40 comprises a substantially rectangular insert, typically moulded from plastics material, with a central square aperture 44 and configured such that module 40 locates over existing actuator switch 26 and sits within channel 30. Insert 42 is formed with a channel 46 on its lower face which receives power pass bar 24, see FIG. 5. Insert 42 is also formed with a vertical channel 50, 50′ proximal each end, these two channels each receiving a lever support arm 52. Prior to insertion of module 40 into channel 30, lever support arms 52 are positioned parallel to internal channel 46 so as to avoid obstructing internal channel 46.

When in use, module 40 is placed over actuation switch 26 so as to lie within channel 30 and lever arms 52 are positioned as shown in FIG. 3. Lever arms 52 are then rotated inwards by 90 degrees to the position shown in FIGS. 4 and 5 so as to be proximal to bar 24. Stop regions 54, 56 formed within insert 42 define how far lever arms 52 can rotate and limit rotation to 90 degrees. Indicia 57 and/or a groove 58 moulded into insert 42 can be used to visually indicate the correct position of lever arms 52.

When a faceplate is fitted onto back box 10 with module 40 in position, actuation switch 26 is depressed by the faceplate to break the terminal connection as shown in FIG. 6. Bar 24 deflects downwards in response to switch 26 but the positioning of lever arms 52 changes the pivot axis of bar 24 ensuring the ends of power pass bar 24 are levered away from connector support blocks 22, 22′ such that there is no physical contact between power pass bar 24 and connector support blocks 22, 22′, nor between power pass bar 24 and terminals 20, 20′. There is thus an air gap between power pass bar 24 and connector support blocks 22, 22′ when the faceplate is in position, producing a lower capacitive coupling and ensuring the operational frequency of a Cisco/Scientific Atlanta back box can be extended above 1.2 GHz without physically removing the back box from the CATV network. This enables the installer to upgrade the operational frequency of the network infrastructure without signal and power disruption compared to full tap replacement.

1. A module for a cable TV network distribution tap comprising an insert locatable over a power pass bar and an activation switch located in a Cisco/Scientific Atlanta back box and at least one support element mounted on the insert and moveable to locate at least part of the at least one support element beneath the power pass bar.

2. A module according to claim 1, wherein the at least one support element is rotatable by 90 degrees between a first position parallel to the power pass bar and a second position where at least part of the at least one support element is beneath the power pass bar.

3. A module according to claim 1, wherein the insert comprises a channel to receive the power pass bar and an aperture to receive an activation switch.

4. A module according to claim 1, wherein the insert further comprises stop regions to limit movement of the at least one support element.

5. A module according to claim 1, where two support elements are mounted proximal opposing ends of the insert.

6. A Cisco/Scientific Atlanta back box incorporating a module according to claim 1.
